(19) United States
(12) Patent Application Publication
(10) Pub. No.: US 2024/0065479 A1
(43) Pub. Date: Feb. 29, 2024

(54) PORTABLE, COLLAPSIBLE COMBINATION GRILL AND SMOKER DEVICE

(71) Applicant: Stan Kopunec, Canyon City, CO (US)

(72) Inventor: Stan Kopunec, Canyon City, CO (US)

(21) Appl. No.: 17/895,990

(22) Filed: Aug. 25, 2022

(51) Int. Cl. A47J 37/07

(52) U.S. Cl. CPC A47J 37/0704; A47J 37/0763; A47J 2037/0777

(57) ABSTRACT

A portable, collapsible combination grill and smoker device for grilling or smoking food with a device that can be collapsed into a portable flat configuration includes a collapsible box with a plurality of panels each pivotably coupled to an adjacent panel such that the collapsible box can be positioned in a flattened configuration wherein all the panels are coplanar with each other. The collapsible box can also be positioned in a deployed configuration to form a box defining a chamber. In the deployed configuration, rods are insertable across the chamber to form a grill for supporting food for cooking.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to combination grill and smoker devices and more particularly pertains to a new combination grill and smoker device for grilling or smoking food with a device that can be collapsed into a portable flat configuration.

### (2) Description of Related Art Including Information Disclosed Under 37 CFR 1.97 and 1.98

The prior art discloses combination grill and smoker devices which fold down for convenient transportation and storage. However, none of these devices are comprised of a plurality of panels which are pivotably coupled such that they flatten into a cross shape and include rods for forming a grill for supporting food while grilling or smoking.

### BRIEF SUMMARY OF THE INVENTION

An embodiment of the disclosure meets the needs presented above by generally comprising a collapsible box comprising a bottom panel, a top panel, a front panel, a back panel, a first lateral panel, and a second lateral panel. The back panel is pivotably coupled to each of the top panel, the bottom panel, the first lateral panel and the second lateral panel. And the front panel is pivotably coupled to the first lateral panel. The collapsible box is positionable in a flattened configuration wherein the back panel is coplanar with each of the bottom panel, the top panel, the first lateral panel, the second lateral panel, and the front panel.

The collapsible box is also positionable in a deployed configuration wherein the first lateral panel is positioned in facing alignment with the second lateral panel and the front panel is positioned in facing alignment with the back panel, while each of the front panel, the back panel, the first lateral panel, and second lateral panel defines a perimeter wall. While the collapsible box is in the deployed configuration, the perimeter wall is positioned on the bottom panel, and the top panel is positioned on the perimeter wall opposite the bottom panel. The collapsible box also defines a chamber when in the deployed configuration.

An air intake hole extends through the front panel proximate a bottom edge of the front panel, and a smoke outlet hole extends through the top panel. A plurality of first rod holes extends through the first lateral panel and is arranged in a row. A plurality of second rod holes extends through the second lateral panel, wherein each second rod hole aligns with an associated first rod hole of the plurality of first rod holes when the collapsible box is in the deployed configuration. A plurality of rods is insertable through the plurality of first rod holes and the plurality of second rod holes when the collapsible box is in the deployed configuration to form a grill.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a collapsible box of a portable, collapsible combination grill and smoker device according to an embodiment of the disclosure in a deployed configuration.

FIG. 2 is a rear view of a collapsible box of an embodiment of the disclosure in a deployed configuration.

FIG. 3 is a left side view of a collapsible box of an embodiment of the disclosure in a deployed configuration.

FIG. 4 is a right side view of a collapsible box of an embodiment of the disclosure in a deployed configuration.

FIG. 5 is a top view of a collapsible box of an embodiment of the disclosure in a deployed configuration.

FIG. 6 is a bottom view of a collapsible box of an embodiment of the disclosure in a deployed configuration.

FIG. 7 is a perspective view of a collapsible box of an embodiment of the disclosure in a deployed configuration.

FIG. 8 is an in-use view of an embodiment of the disclosure.

FIG. 9 is an in-use view of a collapsible box of an embodiment of the disclosure.

FIG. 10 is a front view of a collapsible box of an embodiment of the disclosure in a flattened configuration.

### DETAILED DESCRIPTION OF THE INVENTION

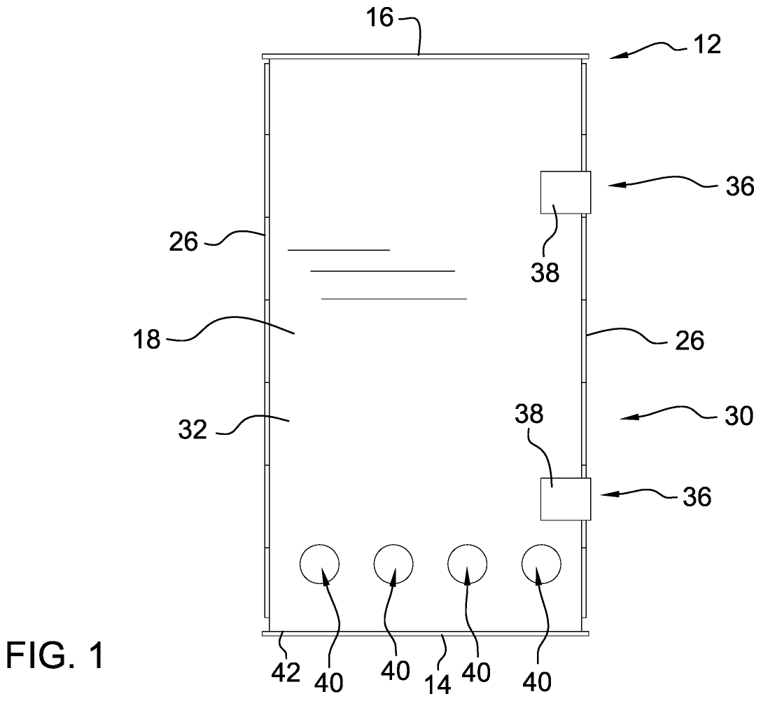

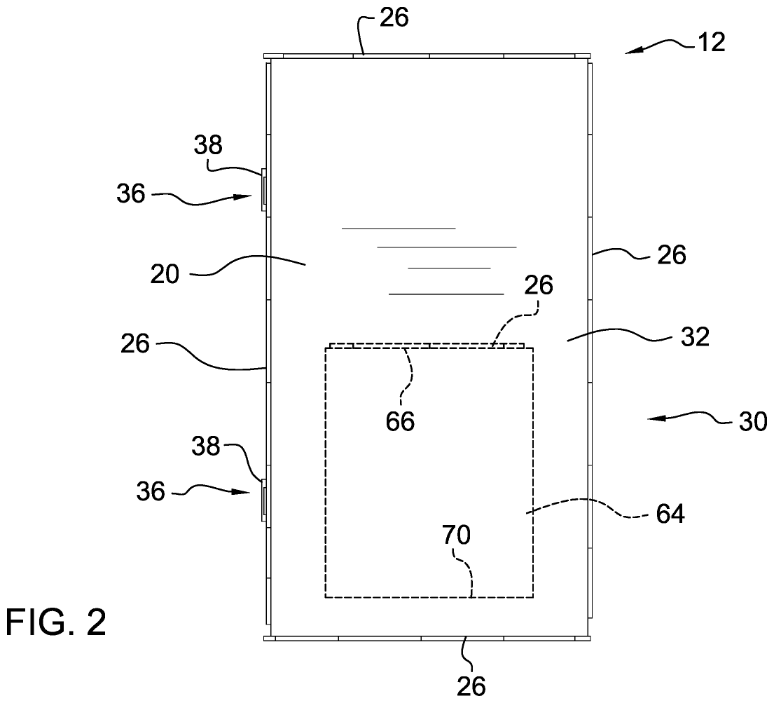

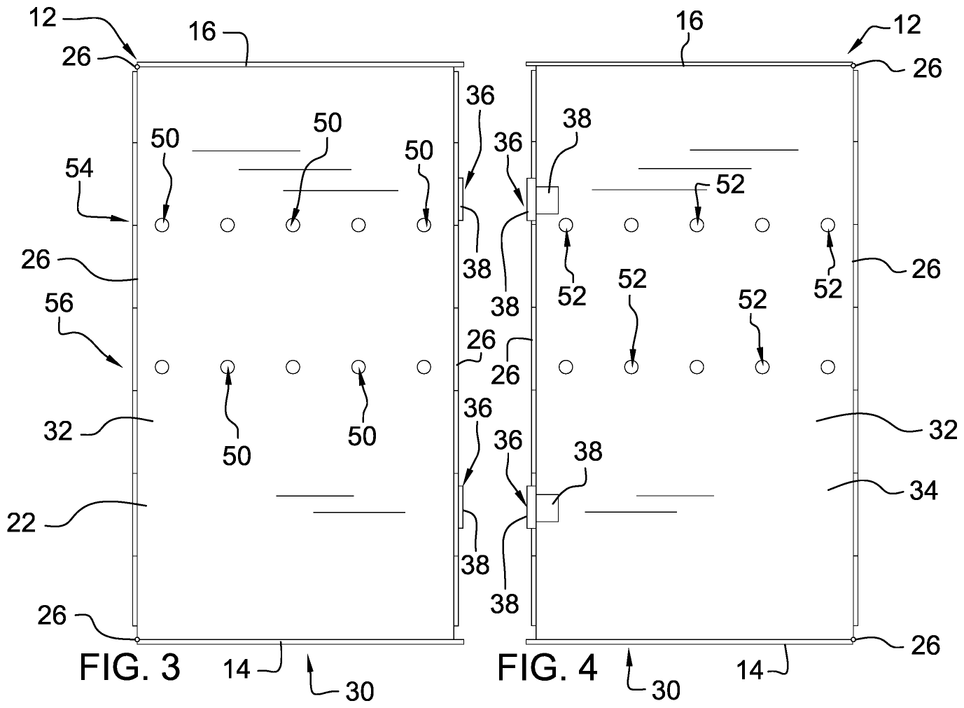

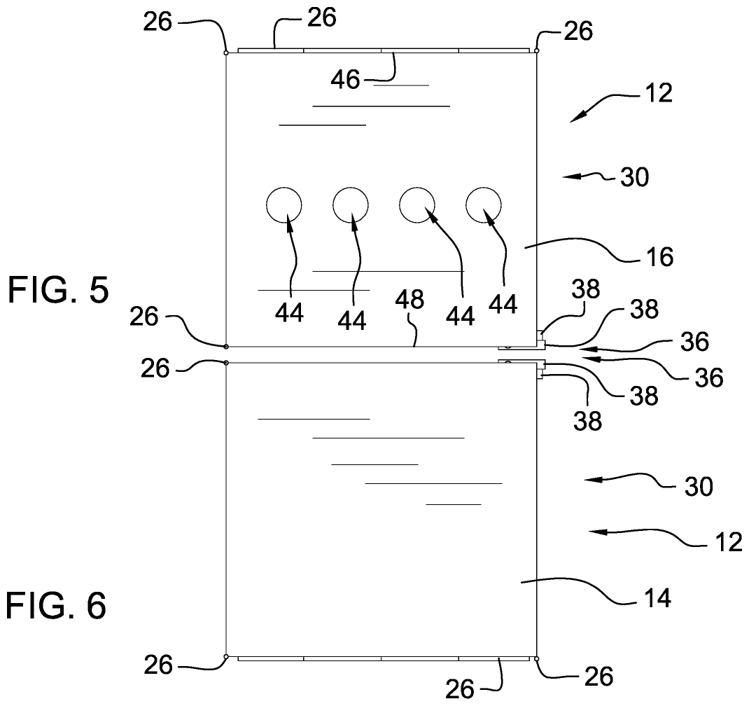

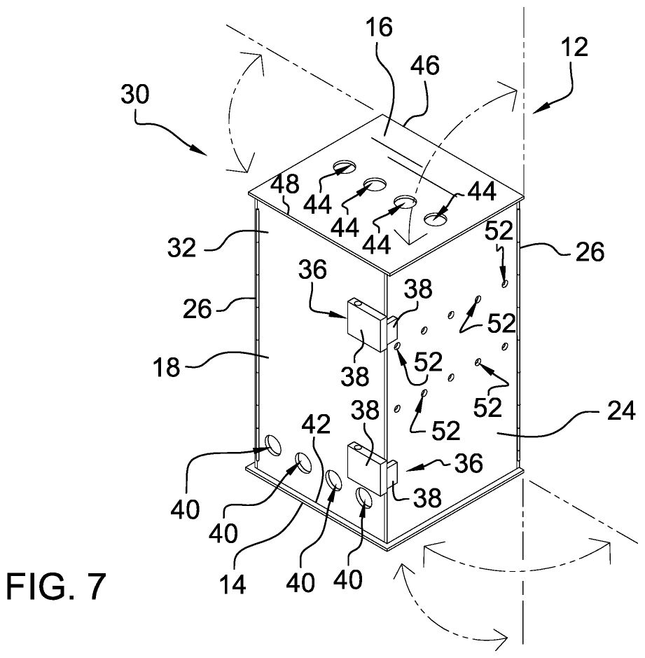

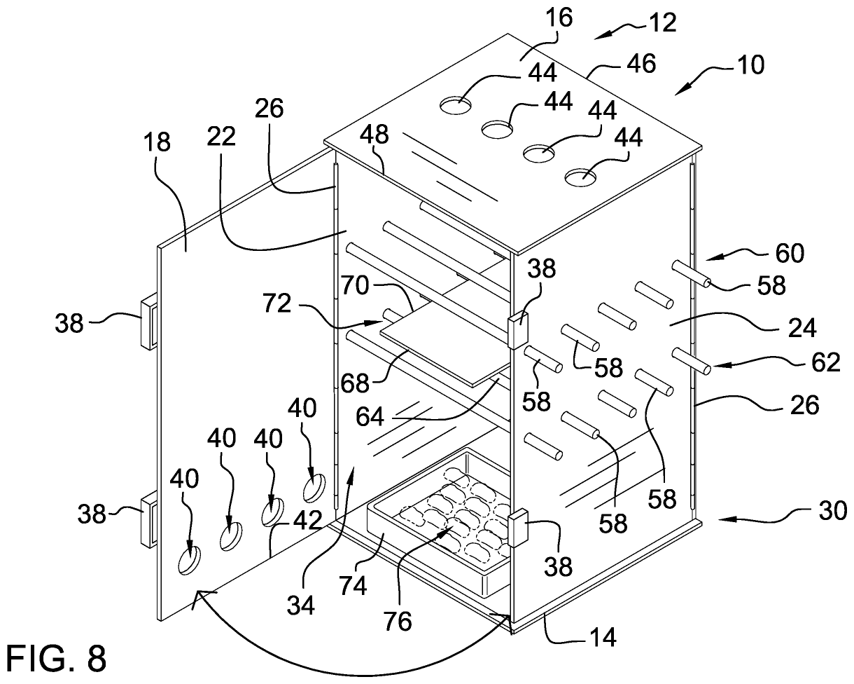

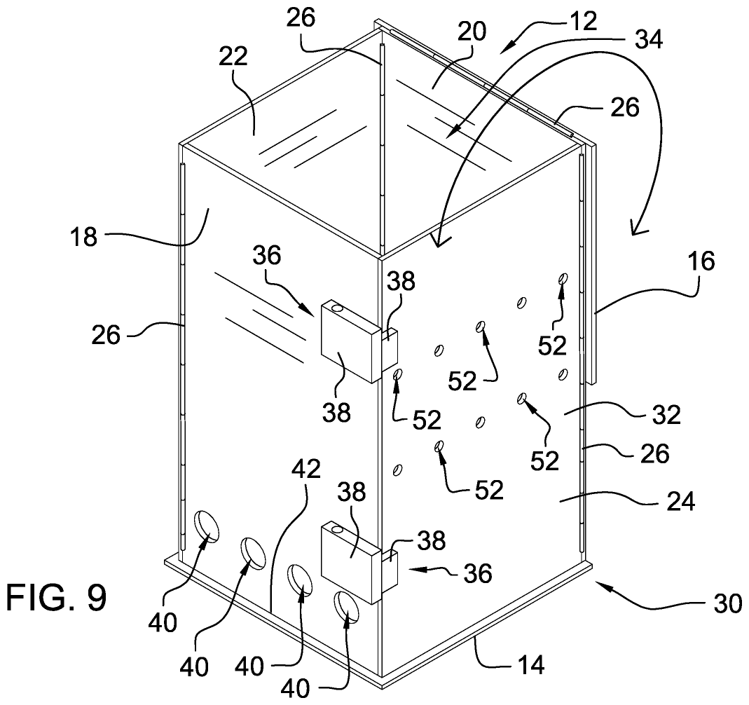

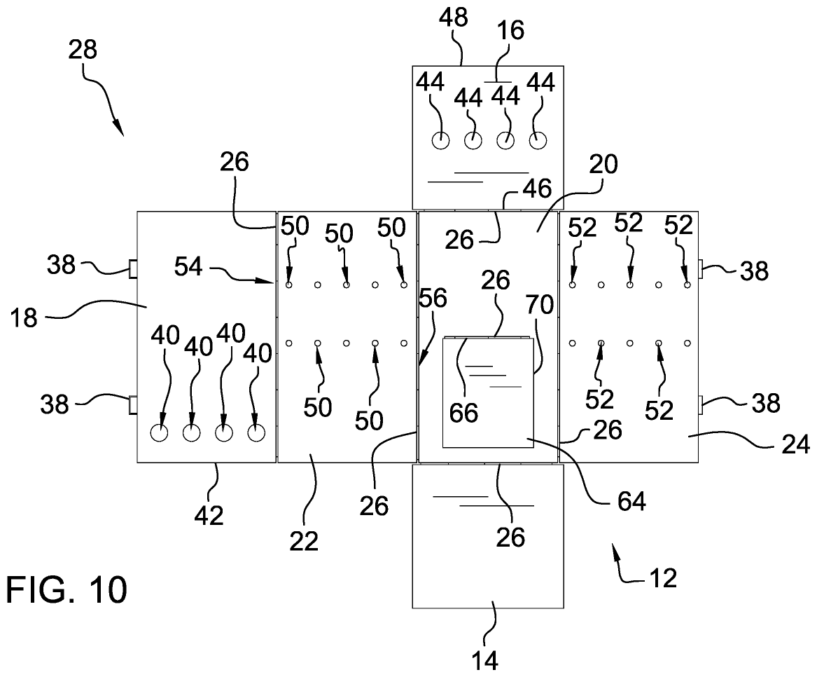

With reference now to the drawings, and in particular to FIGS. 1 through 10 thereof, a new combination grill and smoker device embodying the principles and concepts of an embodiment of the disclosure and generally designated by the reference numeral 10 will be described.

As best illustrated in FIGS. 1 through 10, the portable, collapsible combination grill and smoker device 10 generally comprises a collapsible box 12 comprising a bottom panel 14, a top panel 16, a front panel 18, a back panel 20, a first lateral panel 22, and a second lateral panel 24. The back panel 20 is pivotably coupled to each of the top panel 16, the bottom panel 14, the first lateral panel 22 and the second lateral panel 24 via hinges 26 or the like. And the front panel 18 is pivotably coupled to the first lateral panel 22 via a hinge 26 or the like. The collapsible box 12 is positionable in a flattened configuration 28 wherein the back panel 20 is coplanar with each of the bottom panel 14, the top panel 16, the first lateral panel 22, the second lateral panel 24, and the front panel 18.

The collapsible box 12 is also positionable in a deployed configuration 30 wherein the first lateral panel 22 is positioned in facing alignment with the second lateral panel 24 and the front panel 18 is positioned in facing alignment with the back panel 20. While in the deployed configuration 30, each of the front panel 18, the back panel 20, the first lateral panel 22, and the second lateral panel 24 define a perimeter wall 32 which is positioned on the bottom panel 14. The top panel 16 is also positioned on the perimeter wall 32 opposite the bottom panel 14 and the collapsible box 12 defines a chamber 34 when the collapsible box 12 is in the deployed configuration 30.

Each of a pair of latches 36 has a pair of members 38 that are removably couplable to each other. One of the pair of members 38 is coupled to the front panel 18, while another of the pair of members 38 is coupled to the second lateral panel 24. The pair of latches 36 are capable of removably securing the front panel 18 to the second lateral panel 24. A plurality of air intake holes 40 extends through the front panel 18 proximate a bottom edge 18 of the front panel 18, and a plurality of smoke outlet holes 44 extend through the top panel 16. The plurality of smoke outlet holes 44 is centered between a proximal edge 46 of the top panel 16 relative to the back panel 20 and a distal edge 48 of the top panel 16 relative to the back panel 20.

A plurality of first rod holes 50 extends through the first lateral panel 22 and is arranged in a top row 54 and a bottom row 56, wherein each of the top row 54 and the bottom row 56 is parallel to a bottom edge 18 of the first lateral panel 22. A plurality of second rod holes 52 extends through the second lateral panel 24, and each second rod hole 52 aligns with an associated first rod hole 50 of the plurality of first rod holes 50 when the collapsible box 12 is in the deployed configuration 30. A plurality of rods 58 is insertable through the plurality of first rod holes 50 and the plurality of second rod holes 52 when the collapsible box 12 is in the deployed configuration 30 to form a top grill 60 and a bottom grill 62.

A drip guard panel 64 has a proximal end 66 relative to the back panel 20 which is pivotably coupled to the back panel 20. The drip guard panel 64 has a bottom surface 68 that is positionable on the bottom grill 62 when the collapsible box 12 is in the deployed configuration 30 and the bottom grill 62 is formed. When the bottom surface 68 of the drip guard panel 64 is positioned on the bottom grill 62, a peripheral edge 70 of the drip guard panel 64 and the perimeter wall 32 define a gap 72. The drip guard panel 64 is also positionable with the bottom surface 68 in abutment with the back panel 20 when the collapsible box 12 is in the flattened configuration 28.

In use, the collapsible box 12 is positioned in the deployed configuration 30 and a pan 74 or similar container is placed on the bottom panel 14 with charcoal 76 or another combustion fuel contained within the pan 74. The combustion fuel is lit to begin generating heat for cooking food. To grill with direct heat, the bottom grill 62 is formed using the plurality of rods 58 and a food to be cooked is placed on the bottom grill 62. To smoke or otherwise cook using less direct heat, the top grill 60 is formed and the food to be cooked is placed on the top grill 60. The drip guard panel 64 may optionally be positioned on the bottom grill 62 while cooking with food on the top grill 60 to prevent fat from dripping directly into the combustion fuel while facilitating smoke and heat traveling through the gap 72 between the drip guard pan 74 and the perimeter wall 32.

In either of the cooking methods, air flows freely through the plurality of air intake holes 40, supplying oxygen to the combustion reaction. Smoke and heated air are permitted to leave the chamber 34 through the smoke outlet holes 44. The front panel 18 can be removed from the second lateral panel 24 to access the contents of the chamber 34 and can be removably secured to the second lateral panel 24 via the pair of latches 36. The collapsible box 12 may also be used with the top panel 16 moved away from the perimeter wall 32 to contain a bonfire or to cook food by holding it over a heat source contained by the collapsible box 12. For example, marshmallows may be held over the collapsible box 12 in this configuration to roast them.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable, collapsible combination grill and smoker device comprising:
a collapsible box comprising a bottom panel, a top panel, a front panel, a back panel, a first lateral panel, and a second lateral panel, said back panel being pivotably coupled to each of said top panel, said bottom panel, said first lateral panel and said second lateral panel, said front panel being pivotably coupled to said first lateral panel,
said collapsible box being positionable in a flattened configuration wherein said back panel is coplanar with each of said bottom panel, said top panel, said first lateral panel, said second lateral panel, and said front panel,
said collapsible box being positionable in a deployed configuration comprising:
said first lateral panel being positioned in facing alignment with said second lateral panel, said front panel being positioned in facing alignment with said back panel, each of said front panel, said back panel, said first lateral panel, and second lateral panel defining a perimeter wall;
said perimeter wall being positioned on said bottom panel; and
said top panel being positioned on said perimeter wall opposite said bottom panel;
said collapsible box defining a chamber when in said deployed configuration;
an air intake hole extending through said front panel proximate a bottom edge of said front panel;
a smoke outlet hole extending through said top panel;
a plurality of first rod holes extending through said first lateral panel, said plurality of first rod holes being arranged in a row;
a plurality of second rod holes extending through said second lateral panel, each said second rod hole aligning with an associated first rod hole of said plurality of first rod holes when said collapsible box is in said deployed configuration; and
a plurality of rods being insertable through said plurality of first rod holes and said plurality of second rod holes when said collapsible box is in said deployed configuration to form a grill.

2. The device of claim 1, further comprising at least one latch for removably securing said front panel in a closed position with said second lateral panel, said at least one latch having a pair of members being removably couplable to each other, one of said pair of members being coupled to said front panel, another of said pair of members being coupled to said second lateral panel.

3. The device of claim 2, further comprising said at least one latch being a pair of latches.

4. The device of claim 1, further comprising said air intake hole being one of a plurality of air intake holes.

5. The device of claim 1, further comprising said smoke outlet hole being one of a plurality of smoke outlet holes.

6. The device of claim 1, further comprising said smoke outlet hole being centered between a proximal edge of said top panel relative to said back panel and a distal edge of said top panel relative to said back panel.

7. The device of claim 1, further comprising said plurality of first rod holes being arranged in a top row and a bottom row, said plurality of rods being insertable through said plurality of first rod holes and said plurality of second rod holes when said collapsible box is in said deployed configuration to form a top grill and a bottom grill.

8. The device of claim 7, further comprising a drip guard panel having a proximal end relative to said back panel being pivotably coupled to said back panel, said drip guard panel having a bottom surface being positionable on said bottom grill when said collapsible box is in said deployed configuration and said bottom grill is formed, a peripheral edge of said drip guard panel and said perimeter wall defining a gap when said bottom surface of said drip guard panel is positioned on said bottom grill, said drip guard panel being positionable with said bottom surface in abutment with said back panel when said collapsible box is in said flattened configuration.

9. A portable, collapsible combination grill and smoker device comprising:
a collapsible box comprising a bottom panel, a top panel, a front panel, a back panel, a first lateral panel, and a second lateral panel, said back panel being pivotably coupled to each of said top panel, said bottom panel, said first lateral panel and said second lateral panel, said front panel being pivotably coupled to said first lateral panel,
said collapsible box being positionable in a flattened configuration wherein said back panel is coplanar with each of said bottom panel, said top panel, said first lateral panel, said second lateral panel, and said front panel,
said collapsible box being positionable in a deployed configuration comprising:
said first lateral panel being positioned in facing alignment with said second lateral panel, said front panel being positioned in facing alignment with said back panel, each of said front panel, said back panel, said first lateral panel, and said second lateral panel defining a perimeter wall;
said perimeter wall being positioned on said bottom panel; and
said top panel being positioned on said perimeter wall opposite said bottom panel;
said collapsible box defining a chamber when in said deployed configuration;
a pair of latches for removably securing said front panel in a closed position with said second lateral panel, each latch of said pair of latches having a pair of members being removably couplable to each other, one of said pair of members being coupled to said front panel, another of said pair of members being coupled to said second lateral panel;
a plurality of air intake holes extending through said front panel proximate a bottom edge of said front panel;
a plurality of smoke outlet holes extending through said top panel, said plurality of smoke outlet holes being centered between a proximal edge of said top panel relative to said back panel and a distal edge of said top panel relative to said back panel;
a plurality of first rod holes extending through said first lateral panel, said plurality of first rod holes being arranged in a top row and a bottom row, each of said top row and said bottom row being parallel to a bottom edge of said first lateral panel;
a plurality of second rod holes extending through said second lateral panel, each said second rod hole aligning with an associated first rod hole of said plurality of first rod holes when said collapsible box is in said deployed configuration;
a plurality of rods being insertable through said plurality of first rod holes and said plurality of second rod holes when said collapsible box is in said deployed configuration to form a top grill and a bottom grill; and
a drip guard panel having a proximal end relative to said back panel being pivotably coupled to said back panel, said drip guard panel having a bottom surface being positionable on said bottom grill when said collapsible box is in said deployed configuration and said bottom grill is formed, a peripheral edge of said drip guard panel and said perimeter wall defining a gap when said bottom surface of said drip guard panel is positioned on said bottom grill, said drip guard panel being positionable with said bottom surface in abutment with said back panel when said collapsible box is in said flattened configuration.
